(19) United States
(12) Patent Application Publication
(10) Pub. No.: US 2002/0126122 A1
(43) Pub. Date: Sep. 12, 2002

(54) Apparatus and method for minimizing the idle time of a computer graphic system using hardware controlled flipping

(76) Inventors: Kwo-woei Yet, Miao Li (TW); Chung-hung Tsai, Kaoshiung (TW); Chun-an Tu, Tainan (TW)

Correspondence Address: BIRCH STEWART KOLASCH & BIRCH, PO BOX 747, FALLS CHURCH, VA, 22040-0747, US

(21) Appl. No.: 09/802,942

(22) Filed: Mar. 12, 2001

(51) Int. Cl. G06T 1/00; G09G 5/36

(52) U.S. Cl. 345/522; 345/558

(57) ABSTRACT

An apparatus for minimizing the idle time of a computer graphic system using hardware controlled flipping is provided. The apparatus includes an instruction queue for receiving the instructions from a system bus and a graphic engine for receiving the graphic instructions output from the instruction queue and executing drawing activities. The apparatus further includes a flipping instruction queue for receiving the flipping instructions from the instruction queue and a display controller for controlling the activities of displaying image. The instruction queue transmits the flipping instruction to the flipping instruction queue first when an empty space is available in the flipping instruction queue and then transmits the sequential instructions other than the flipping instruction to the graphic engine. Therefore, it can reduce the idle time of the graphic engine waiting for the flipping activity. Furthermore, the flipping instruction queue outputs a flipping instruction when the graphic engine is idle and the flipping instruction queue receives a vertical trigger signal transmitted from the display controller.

### BACKGROUND OF THE INVENTION

1. Field of the Invention

The invention relates to an apparatus and a method for minimizing the idle time of a computer graphic system, and particularly to an apparatus and a method for minimizing the idle time of a computer graphic system using hardware controlled flipping.

2. Description of the Related Art

FIG. 1 shows a control flowchart of a conventional “three-dimensional” (3-D) display. In the control flowchart of the conventional 3-D display, the 3-D application program 100 uses several special 3-D graphic data banks 101 such as “Direct 3D” and “OpenGL” to assist the design of a final 3-D display. Such graphic data bank 101 converts a 3-D object into a graphic data primitive with a drawing attribute. The 3-D object is converted from the “world coordinate” that defines the objects in space into the “screen coordinate” that defines the positioning coordination projected on a display screen. Afterwards, a driver of a display apparatus 103 transmits the graphic data primitive with the special hardware instruction to a graphic acceleration apparatus 104, and then the graphic acceleration apparatus 104 is used to draw the graphic image on the display 105.

FIG. 2 shows a control block diagram of a graphic acceleration apparatus usually used for the flowchart control of the 3-D display. As shown in FIG. 2, the conventional graphic acceleration apparatus 104 includes an instruction queue 106, a graphic engine 107 and a memory controller 108. The instruction queue 106 receives the graphic instructions of the 3-D graphic data primitive through a system bus from the driver of display apparatus 103 and stores the instructions in a queue formation. Afterwards, the graphic engine 107 sequentially receives the instructions from the instruction queue 106 and executes the instructions received. And, the memory controller 108 is used to store the data calculated and generated by the graphic engine 107 in a graphic memory 109 through a memory bus.

In the application of animate picture of multimedia, the graphic system usually uses two sets or more memory buffers for storing data. As shown in FIG. 3, a graphic system uses three sets of memory buffer. The first buffer is called the “front buffer” and the other two are called the “back buffers”. When the system is displaying a picture stored in the front buffer, the 3-D graphic system can draw the graphic data of a new picture in the back buffer. In other words, the picture in the front buffer is displayed on the screen by the display system when the new picture for display next is drew in the back buffer by the graphic system. When the new picture in the back buffer is completed, the graphic system can just execute a flipping activity so that the completed back buffer is switched to the front buffer so as to display the new picture. Therefore, as shown in FIG. 3B and FIG. 3C, the switching activity is performed continuously as long as that is required by the animate picture.

When all the graphic data primitive for display next has been completed in the back buffer by the graphic system, the graphic system generates a flipping instruction for the buffer. After the graphic system has completed the picture for display next and requests a flipping activity, the controller of display apparatus does not allow the graphic program to draw a new picture in the front buffer if the picture in the front buffer is still being displayed. Therefore, the controller of display apparatus keeps inquiring until the graphic engine 107 is idle and the vertically synchronous signal of the display is detected, and then the flipping instruction is executed in order to avoid generating the image tearing. This flipping method is known as the “software controlled flipping”. However, under this situation, the flipping instruction stays in the instruction queue while the controller of display apparatus keeps inquiring whether the flipping activity can be executed or not when the flipping instruction is met. Thus, the activity of the host is idle and the application program is stalled until the graphic acceleration apparatus completes the flipping instruction. Therefore, this control flowchart of software controlled flipping wastes the resource of the graphic engine.

### SUMMARY OF THE INVENTION

In view of the above-mentioned problems, one of objects of the invention is to provide an apparatus and a method for minimizing the idle time of a computer graphic system using hardware controlled flipping.

Another object of the invention is to provide an apparatus and a method for reducing the idle time of a computer graphic system using hardware queue to store the flipping instructions.

In order to achieve the above-mentioned objects, the computer graphic system using hardware queue to store the flipping instructions for reducing the idle time according to the invention includes an instruction queue for receiving the instructions through a system bus. And, the computer graphic system further includes a graphic engine for receiving the instructions output form the instruction queue and then executing the drawing activities. And, the computer graphic system further includes a flipping instruction queue for receiving the flipping instructions from the instruction queue and a display controller for controlling the activities of displaying image. Furthermore, the instruction queue transmits the flipping instruction to the flipping instruction queue in advance when an empty space is still available in the flipping instruction queue. Then, the instruction queue transmits the sequential instructions other than the flipping instruction to the graphic engine so as to reduce the idle time of the graphic engine.

In addition, the flipping instruction queue according to the invention outputs a flipping instruction until the graphic engine is idle and the flipping instruction queue receives a vertical trigger signal from the display controller.

The flipping instruction queue provided inside the graphic acceleration apparatus to store the flipping instruction in advance is employed by the computer graphic system using a hardware queue to store the flipping instructions for reducing the idle time according to the invention. And, the flipping instruction is executed after the vertically synchronous signal from the display controller is detected. Therefore, the graphic engine keeps executing the graphic instructions in the period of time waiting for the vertically synchronous signal so as to reduce the idle waiting time of the driver of display apparatus. The efficiency of the graphic acceleration apparatus is enhanced thereby.

### BRIEF DESCRIPTION OF THE DRAWINGS

These and other objects, features and advantages of the invention will become apparent with reference to the following description and accompanying drawings as follows.

FIG. 1 is a control flowchart of a conventional 3-D display.

FIG. 2 is a block diagram of a conventional graphic acceleration apparatus.

FIG. 3 is a schematic diagram of using a conventional back buffer.

FIG. 4 is a block diagram of a graphic acceleration apparatus according to the invention.

FIG. 5 is a configuration of an instruction and a memory buffer according to the invention.

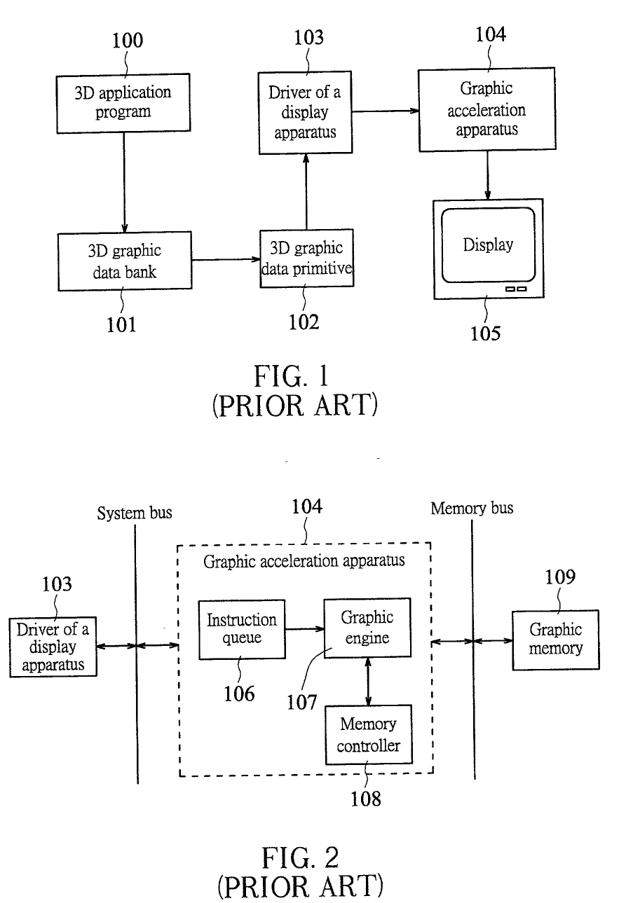

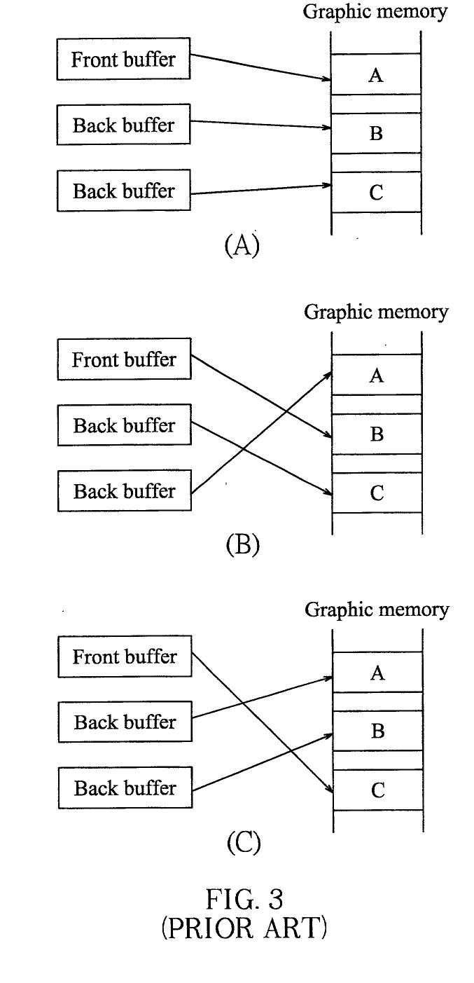

### DETAIL DESCRIPTION OF THE INVENTION

The aspects of embodiments of an apparatus and a method for minimizing the idle time of a computer graphic system using hardware controlled flipping according to the invention is illustrated with reference to the accompanying drawings as follows.

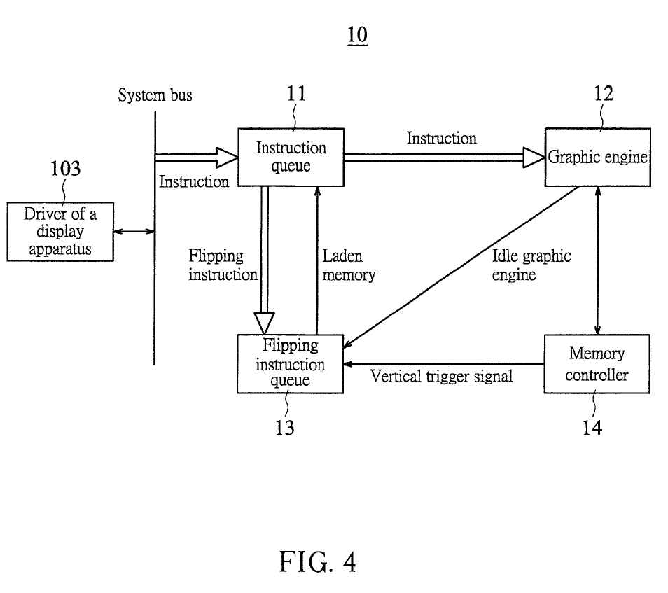

FIG. 4 is a block diagram of a graphic acceleration apparatus of a computer graphic system according to the invention. As shown in FIG. 4, the graphic acceleration apparatus 10 includes an instruction queue 11, a graphic engine 12, a flipping instruction queue 13 and a memory controller 14. Wherein, the instruction queue 11 reads the instructions from a driver of display device 103 through a system bus, and the graphic engine 12 sequentially receives and executes the graphic instructions from the instruction queue 11. The memory controller 14 is used to store the data calculated and generated by the graphic engine 12 in a graphic memory (not shown) through a memory bus.

In addition, the flipping instruction queue 13 is a memory queue for receiving the flipping instructions transmitted from the instruction queue. The memory capacity of the flipping instruction queue 13 is determined according to the number of the back buffers used. In other word, the more number of back buffers is, the more memory capacity of the flipping instruction queue 13 must have. When the memory of the flipping instruction queue 13 is full, the flipping instruction queue transmits a “full” signal to the instruction queue 11. Thereby, the instruction queue 11 is notified that it is not allowed to output the graphic instruction to the graphic engine 12 because no back buffer is available for drawing at this moment.

The instructions stored in the instruction queue 11 can be classified into two types that one type is the graphic instruction for being transmitted to the graphic engine 12 and the other type is the flipping instruction for being transmitted to the flipping instruction queue 13. When the graphic engine 12 is idle after having drawn a picture completely, the instruction queue 11 outputs a flipping instruction to the flipping instruction queue 13 for storage. Therefore, since the flipping instruction does not stay in the instruction queue 11, the flipping instruction does not prevent the graphic instructions of the next picture in succession from being transmitted to the graphic engine 12 continuously. Moreover, when the flipping instruction queue 13 still holds one flipping instruction, the flipping instruction queue 13 keeps monitoring the displaying status of a display. When the flipping instruction queue 13 detects a vertically synchronous signal of the display, the flipping instruction queue 13 pops out a flipping instruction notifying the memory controller 14 to execute a flipping activity.

Therefore, the graphic acceleration apparatus according to the invention can effectively utilize the period of time after the graphic engine 12 is idle until the display generates the vertically synchronous signal. And, the graphic engine 12 utilizes the period of time to continuously execute the graphic instructions and to further reduce the waiting time of the graphic acceleration apparatus.

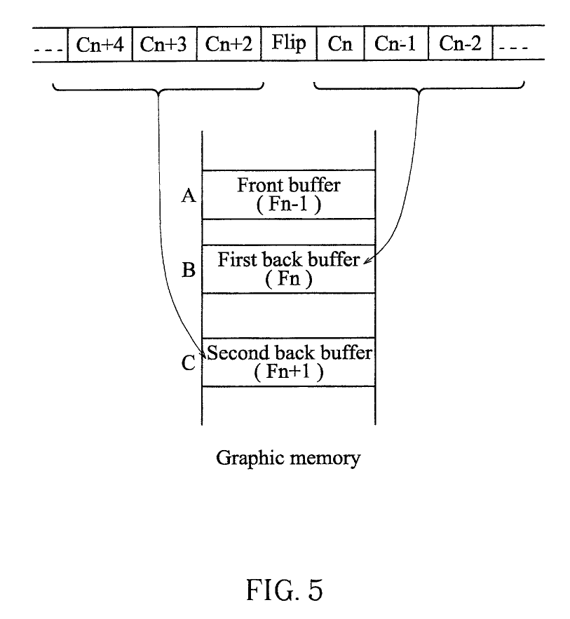

FIG. 5 illustrates the relationship of the instruction and memory employed in the invention. As shown in FIG. 5, the buffers used in the invention include an area A, an area B and an area C. Currently the area A is the front buffer storing the Fn−1^{th} picture of an image, and the area B is the first back buffer storing the Fn^{th} picture of the image while the area C is the second back buffer storing the Fn+1^{th} picture of the image. The continuous instructions shown in FIG. 5 are Cn−2, Cn−1, Cn, Flip, Cn+2, Cn+3, Cn+4, and so on. Therefore, as shown in FIG. 5, the graphic instructions Cn−2, Cn−1, Cn are drew in the first back buffer of area B while the graphic instructions Cn+2, Cn+3, Cn+4, and so on are drew in the second back buffer of area C. When the graphic instructions corresponding to the Fn^{th} picture of the image has been executed completely, the graphic engine 12 outputs an idle signal. At this moment, the Flip instruction is transmitted to the flipping instruction queue 13 from the instruction queue 11. Therefore, the instruction queue 11 keeps transmitting the instructions Cn+2, Cn+3, Cn+4, and so on corresponding to the Fn+1^{th} picture of the image to the graphic engine 12 without waiting for the vertically synchronous signal generated by the display.

Therefore, the invention utilizes the flipping instruction queue to store the flipping instructions in advance in order to allow the graphic instructions of the next graphic to be transmitted to the graphic engine continuously. And, it is not necessary to wait for the picture of the front buffer being displayed completely. Thus, the idle waiting time of the graphic engine can be reduced effectively.

The apparatus and the method for minimizing the idle time of a computer graphic system using hardware controlled flipping according to the invention is illustrated in the aspect of embodiment as described above. It should be understood that various alternatives to the structures described herein may be employed in practicing the invention. It is intended that the following claims define the invention and that the structure within the scope of these claims and their equivalents be covered thereby.

What is claimed is:

1. An apparatus for minimizing the idle time of a computer graphic system using hardware controlled flipping comprising:
an instruction queue for receiving instructions from a system bus;
a graphic engine for receiving the instructions output from said instruction queue and for executing drawing activities;
a flipping instruction queue for receiving flipping instructions from said instruction queue; and
a display controller for controlling the activities of displaying image;
wherein, when said graphic engine is idle and an empty space is available in said flipping instruction queue, said instruction queue transmits the flipping instruction to said flipping instruction queue first and then transmits the sequential instructions other than the flipping instruction to said graphic engine so as to reduce the idle time of said graphic engine.

2. The apparatus for minimizing the idle time of a computer graphic system using hardware controlled flipping of claim 1, wherein said flipping instruction queue outputs a flipping instruction when it receives a vertical trigger signal transmitted from said display controller.

3. The apparatus for minimizing the idle time of a computer graphic system using hardware controlled flipping of claim 1, wherein said flipping instruction queue transmits a “full” signal to said instruction queue.

4. A method for minimizing the idle time of a computer graphic system using hardware controlled flipping, the method comprising steps of:
receiving instructions from a system bus and storing the instructions by an instruction queue;
receiving graphic instructions from said instruction queue and executing drawing activities by a graphic engine;
receiving and storing flipping instructions from said instruction queue when said graphic engine is idle by a flipping instruction queue; and
executing a flipping activity and outputting a flipping instruction stored in said flipping instruction queue by said flipping instruction queue when said flipping instruction queue has the flipping instruction and detects a vertical trigger signal of a display;
wherein, the flipping instruction is transmitted to said flipping instruction queue in advance and then the sequential instructions other than the flipping instruction are continuously transmitted to said graphic engine so as to reduce the idle time of said graphic engine.

5. The method for minimizing the idle time of a computer graphic system using hardware controlled flipping of claim 4, wherein the method further comprising a step of transmitting a “full” signal from said flipping instruction queue to said instruction queue.
